(19) United States
(12) Patent Application Publication
(10) Pub. No.: US 2002/0116247 A1
(43) Pub. Date: Aug. 22, 2002

(54) Public-initiated incident reporting system and method

(76) Inventors: Kathleen Ann Tucker, San Diego, CA (US); Teri Lynn Schroeder, Oceanside, CA (US)

Correspondence Address: KATHLEEN ANN TUCKER, 9555 Whellock Way, SAN DIEGO, CA, 92129, US

(21) Appl. No.: 10/074,085

(22) Filed: Feb. 12, 2002

Related U.S. Application Data
(60) Provisional application No. 60/269,192, filed on Feb. 15, 2001.

(51) Int. Cl. G06F 17/60

(52) U.S. Cl. 705/8

(57) ABSTRACT

This is a computerized system that leverages web technologies to provide the mechanism by which the public-at-large can self-initiate the report of an incident, and whereby the system captures data pertinent to the incident in the form of a logical association of all elements of the incident; including, but not limited to: victim, reporting party, location, narrative, incident details, and suspect information. This invention is a remarkable, innovative, and unprecedented system and method that: 1) enables the public-at-large to electronically create an incident report via the Internet, an intranet, or an extranet; 2) guides the public through the process of creating an incident report; 3) profiles the elements of the incident through iterative sets of logically related questions and answers; and, 4) automatically notifies one or more law enforcement agencies of the submission of an incident report by a member of the public-at-large.

### CROSS-REFERENCE TO RELATED APPLICATIONS

This application claims priority from United States Provisional Patent Application No. 60/269,192; filing date Feb. 15, 2001; name of applicant(s) Kathleen Ann Tucker and Teri Lynn Schroeder; and, title of invention: “Public-initiated incident reporting system and method.”

### STATEMENT REGARDING FEDERALLY SPONSORED RESEARCH OR DEVELOPMENT

There has been no federally sponsored research nor development associated with this invention.

### REFERENCE TO SEQUENCE LISTING, A TABLE, OR A COMPUTER PROGRAM LISTING COMPACT DISK APPENDIX

Not Applicable

### BACKGROUND OF THE INVENTION

Field of Endeavor. This invention relates generally to a computerized system that enables communication between the public-at-large and one or more law enforcement agencies for the purpose of: initiating an incident report pertaining to an event known to the reporting party, the collection of data pertinent to that incident, the notification of one or more law enforcement agencies about said incident, the accessibility by law enforcement to the data collected about the incident, and the ability to provide access to the data by multiple law enforcement agencies for collaborative and investigative purposes. This invention leverages new and emerging web technologies to provide a mechanism whereby a person, or a representative of an organization, that has been the victim of, or who is a witness to, a crime or other incident can report that incident to a law enforcement agency via the Internet, an intranet, or an extranet. Currently, when a person needs to make law enforcement aware of an incident, that person cannot electronically initiate an incident report (via a computerized system); but rather, must call a law enforcement agency or must appear in person at a law enforcement agency. Current processes and technologies used to initiate an incident report are focused internally, within the law enforcement agency, and the initiation of the incident report is made by a law enforcement officer or authorized representative, not by the public-at-large.

The problem this invention solves and prior art. According to research findings published by the National Institute of Justice, U.S. Department of Justice, in the August 2000 Research in Brief: “A compelling need exists to better address the requirements of State and local law enforcement agencies in detecting, investigating, and prosecuting individuals who commit electronic crimes.” Over the past several years, home computers along with access to the Internet by the general public has brought great rewards but has also resulted in new threats to society, specifically: electronic crime (cyber crime). As Internet use continues to grow, so will the number of cyber criminals. These criminals are sexual predators, pornographers, hackers, and thieves. They target, and then victimize, innocent people—especially youth—via this emerging electronic highway. Crimes vary from theft of credit card information and personal identities to solicitation of sexual acts, stalking, and hacking. Many of the crimes are new crimes (e.g. computer hacking), while other crimes, child predation for example, have haunted law enforcement officers for centuries. Regardless of the nature of the crime, the criminal's method of attack—the Internet—is relatively new. The Internet has changed the rules of the game. No longer are criminals constrained by geographical or physical barriers (such as having access to places where children frequent); now, predators can easily stalk their prey electronically—without ever leaving home. Child molesters can enter cyber areas where children play and they can “virtually” enter the child's home—even be invited into the home as a cyber friend. These new crimes, and the new way that criminals commit old crimes, require new tools for law enforcement. Without new tools to combat cyber crimes, law enforcement is at an exceptional disadvantage.

In this same report (August 2000 Research in Brief), the National Institute of Justice goes on to identify ten, critical, priority needs, one of which is the need for more comprehensive data about electronic crime. To address this need, the FBI changed its Uniform crime Reporting System to reflect computer-related criminal action and the FBI requires those law enforcement agencies that report to the Nation Incident Based Reporting System (NIBRS) to indicate whether a computer was used by the perpetrator during the commission of the crime. This is a step forward in the collection process, but even the National Institute of Justice recognizes that it falls short of meeting the need by stating: “however, additional details about the use of computers in crime are needed to fully measure the incidence of electronic crime. More comprehensive data is needed to establish a clearer picture of the extent and impact of electronic crime and to monitor trends.” NIBRS and this invention are similar in that data is collected about multiple types of incidents; not just electronic (cyber) crimes. However, NIBRS differs significantly from this invention due to the fact that NIBRS is a back-end collection and reporting system that receives incident reporting information directly from law enforcement agencies and is not intended to provide a mechanism by which the public-at-large can self-initiate an incident report. This invention is a front-end system that provides the public-at-large with the ability to self-initiate an incident report.

Another law enforcement system that addresses the problem of detecting and investigating criminal activity in general, including information about electronic criminal activity, is the FBI's Law Enforcement Online (LEO) network. LEO is a secured network where law enforcement personnel can go online and participate in chat rooms with other officers, receive alerts and training bulletins, and access areas of specific interest (such as bomb and arson newsgroups). Similar to this invention, LEO provides an area for collaboration; but, unlike this invention, it is not intended to collect nor store incident information as an investigative repository that can be searched by law enforcement personnel across the nation.

In addition to the FBI systems, there are local agency systems (Record Management Systems) that collect and store data pertinent to incidents within a specific agency's jurisdiction. These Record Management Systems may have been developed in-house or purchased from a software vendor. This invention is complimentary to existing Record Management Systems and may be used as a front-end application to those systems. Current Record Management Systems are not designed to provide access by the public-ar-large to self-initiate and incident report via electronic means. Additionally, most current systems are self-contained with an agency or small group of geographically-related agencies and generally do not electronically share data among agencies. This can seriously hinder investigation and prosecution. Now, more than at any other time in history, law enforcement agencies need access to the details (not just summary statistics) of incidents that occur outside of their jurisdictional boundaries and outside of their self-contained records management and incident reporting systems. To illustrate: Via the Internet, criminals stalk their victims without constraint. A victim in Florida may report an Internet-related incident to her local law enforcement agency, while a California victim of the same cyber predator reports her Internet-related incident to her local law enforcement agency, and the same happens in Virginia. As long as law enforcement is unable to access a repository of these incidents, the connection of these three victims to the single predator will remain unknown.

The Automated Regional Justice Information System (ARJIS) in San Diego, Calif. is an exception. ARJIS is a collaborative system used by multiple agencies in the San Diego region. It does not, however, allow public-initiated incident reporting nor Internet access to its databases by agencies outside of the San Diego region for investigative purposes. ARJIS is primarily an aging mainframe application that is limited and cumbersome to modify. This invention is not intended to replace the extensive functions of ARJIS nor other Records Management Systems, rather this invention is complimentary to, and improves systems, like ARJIS and other current Records Management Systems. This invention provides a new way of capturing incident data—through public-initiated incident reporting using web technologies via the Internet, local intranets, and extranets—as well as providing access to an investigative repository by law enforcement agencies nation-wide (potentially, world-wide). This invention brings new technology, a new approach, and a new method to the detection of an incident, the investigation of an incident, and the prosecution of individuals who perpetrate those incidents. This invention will provide an Application Program Interface (API) that will allow incident data collected by this invention to be automatically downloaded to a law enforcement agency's local Records Management System or incident reporting system and conversely will provide an Application Program Interface (API) that will allow incident data collected by an agency's local Records Management System or incident reporting system to be uploaded in to this invention's investigative repository.

The CyberTipline is a similar concept to this invention. The CyberTipline is an initiative of the National Center for Missing and Exploited Children (NCMEC) and as such is exclusively focused on the reporting of incidents of child exploitation crimes. The CyberTipline provides an online form for the public-at-large to use to report actual or potential incidents of child exploitation crimes. The system is only used to report incidents related to: the possession, manufacture and distribution of child pornography; the online enticement of children for sexual acts; child prostitution; child-sex tourism; and, child sexual molestation (not in the family). No other incident types are accepted. Additionally, the data that is collected in the CyberTipline is all funneled through a single agency (NCMEC) for review and prioritization before the incident is shared with other Federal Agencies. It doesn't appear that State or local law enforcement agencies are able to access the incident reports, modify the reports, perform queries against data collected from multiple reports, nor export data from the reports collected in this system to their local agency systems. This invention differs significantly from the CyberTipline in each of these aspects. Additionally, this invention is capable of collecting data relevant to any type of incident, this invention is not limited in scope, and therefore is a powerful law enforcement tool for forming relationships among incidents based on data within numerable, multi-faceted incidents.

### BRIEF SUMMARY OF THE INVENTION

Detection of a criminal event occurs in many forms, but the fact that criminal activity has transpired is conveyed to law enforcement through the report of an incident. Current incident reporting systems, and records management systems, restrict the generation of an incident report to an authorized representative of the law enforcement agency, such as: a sworn officer, 911 operator, or data entry clerk. These systems do not provide the ability for the public-at-large to self-report incidents in which the data about these incidents is stored, in such a manner, as to allow multiple agencies to perform investigative queries against that data. According to the National Institute of Justice (August 2000 Research in Brief), “there is a near-term window of opportunity for law enforcement to gain a foothold in containing electronic crimes, which presently outpace most agency investigative resources.” Without new tools for data collection and investigation, law enforcement agencies are at a distinct disadvantage against electronic crime offenders.

This invention provides a technological tool that will be an integral component of any solution that addresses the key issues identified by the National Institute of Justice for the detection and investigation of electronic crime; and, this invention provides assistance with the third key issue: prosecution. This invention is not limited in scope to the collection of electronic crime incidents; any incident can be captured through this invention, however, this invention has been specifically designed to capture those data elements that are unique to electronic incidents and does specifically address the needs of law enforcement in their battle against the insurgence of electronic criminal activity: child pornography, personal identity theft, hacking, cyber stalking, and many more cyber crimes. It is important to note that this invention provides a mechanism for the collection of data related to incidents that are not life-threatening and this invention is not intended to replace nor supplant current emergency response (911) systems.

The method of this invention is to provide: 1) a mechanism for the capture of non life-threatening incident data directly from the public via the Internet, an intranet, or an extranet using a wizard to guide the reporting party easily and intuitively through the process, 2) notification to a designated agency or agencies that an incident has been initiated, 3) the ability for a law enforcement agency to leverage the data collected in the initial incident report to create an official agency incident report that can be modified by a law enforcement officer or authorized representative during the investigation of the incident and can be used as an official report of the incident if that agency so chooses, 4) one or more agencies access to all incident data contained in the investigative repository by spanning jurisdictional and geographical boundaries (however, an agency can elect to use this invention as a stand-alone and not allow access by other law enforcement agencies), and 5) Application Program Interfaces (API's) that will allow incident data collected by this invention to be available for download to an agency's local Records Management System or incident reporting system and conversely, to allow incident data collected by an agency's local Records Management System or incident reporting system to be uploaded in to this invention's investigative repository.

This invention, which provides for the initiation of an incident report by the general public, as opposed to creation of the report only by an authorized law enforcement agency designee, has distinct advantages over the current methods. The first advantage is the increased detection of incidents. Just as the telephone allowed more people to make contact with law enforcement in that they no longer had to physically locate an officer, they could call from their homes; the Internet will allow more people to make contact with law enforcement if enabling technology and methods are provided. This invention provides both the technology and the methods for the public to initiate, and a law enforcement agency to receive, an incident report; thus, enabling both law enforcement personnel and the public-at-large to leverage advancements in communication technologies and to transition from dated means of communication to newer technologies—enabling a paradigm shift in the method of initiating the report of incident by the general public to law enforcement.

Using current technologies, when a citizen wants to report an incident, such as the theft of property, that citizen contacts a law enforcement agency and either provides information over the phone or an officer has to be dispatched to meet with the citizen and capture the details of the incident. Often times, the officer takes down the information on a pre-printed incident report form and the information from that form is then key-punched by another person into the agency's Records Management or incident reporting system. Some current systems allow the officer to directly enter the data into a mobile data terminal whereby the data is uploaded to the local system. This current method, whether the information is entered by a data entry clerk or by a police officer presents several problems that this invention improves: 1) With this invention, an officer is neither required to take information over the phone about an incident, nor is an officer required to be dispatched to physically meet with the reporting party; the reporting party will enter the incident information directly into the system, thus freeing up valuable law enforcement resources for more critical activities. 2) This invention reduces data entry errors. Since the person reporting the incident is the one entering the data directly into the report, there is a reduced likely-hood that names and addresses and other pertinent information will be misspelled. Any time multiple people are involved in entering data or transforming data from one medium to another, there is an increased probability of error.

After an incident report has been initiated, the system will notify one or more law enforcement agencies of the incident report. The business rules for determining the appropriate notification are set by parameters agreed upon by the law enforcement agencies that are utilizing this invention. Several parameters will be available for use in determining the appropriate agency to be notified, including, but not limited to: location of the incident being reported, location of the victim, the desire by the participating agencies to have a central agency receive all incident reports or to have the reports filtered before they a specific agency is notified.

After the incident report is initiated, the data contained within the report is made available to an authorized representative of the notified agency (for the purposes of this description we will refer to the authorized representative as “officer”). The system will provide the officer with access to the incident report. The system will provide the officer with the ability to modify the report and to create an official agency incident report from the data contained in the initial incident report. The system will provide Application Program Interfaces (API) that will allow data from the incident report, created within this system, to be exported to an external, local agency's Records Management or incident reporting system. In actuality, the API will allow the export of the incident data to any type of back-end, agency system; including, for example, the CyberTipline.

Any data collected in this process can be stored in the investigative repository. There will be a method for identifying if this is raw data, as input by the reporting party, or if this is a verified incident and official data recognized by the agency that is investigating the incident. All agencies will have access to the repository so that incidents reported in one jurisdiction can be matched with incidents occurring in other jurisdictions. The investigative repository proffered by this invention is, in and of itself, a profound benefit in the investigation of criminal incidents. Collaboration is one of the key—missing—elements within the current systems. Because the current systems (exception is ARJIS, even though it too is limited to only specific agencies and cannot be accessed by agencies across the nation) are contained locally by their respective agencies, the data in their repositories are not integrated, and thus recognition of related incidents across local systems is virtually impossible. Even though NIBRS is a National Incident Based Reporting System, the data within the system is not real-time; it is a back-end collection system. With NIBRS information there is a time delay between the time the data is reported to a law enforcement agency and the time the incident data is batched and transmitted to NIBRS. This invention provides for real-time collection of incident information; this invention is a front-end collection system.

### BRIEF DESCRIPTION OF THE DRAWINGS

FIG. 1 depicts the process whereby any person, referred to in the collective as the public-at-large, will be able to create a Public-initiated incident report via the Internet, an intranet, or an extranet and have that incident report trigger an automatic notification of one or more law enforcement agencies or other appropriate agencies. It depicts the use of the invention's Reporting Wizard to guide the Reporting Party (referred to as the User or RP) through the process of filling out the data relevant to an incident report. It also identifies the invention's ability to systematically determine the nature of the incident by logically presenting a series of questions that profile multiple types of incidents: e.g. solicitation, stalking, theft, pornography.

FIG. 2 depicts the process that a law enforcement officer, or authorized agency representative, will use to view and act upon Public-initiated incident reports. It depicts the process supported by the invention to aid the officer in receiving, reviewing, and investigating a Public-initiated incident report. It also identifies potential bi-directional data transfer points between the investigative repository within this invention and a law enforcement agency's local Records Management System or other legacy information systems.

FIG. 3 provides another view of how any person, regardless of geographic boundaries, who has access to the Internet, can initiate this invention through a graphical user interface. FIG. 3 also depicts how this invention controls the actions of the User from a protected (hosted) site that resides behind the hosting organization's firewall.

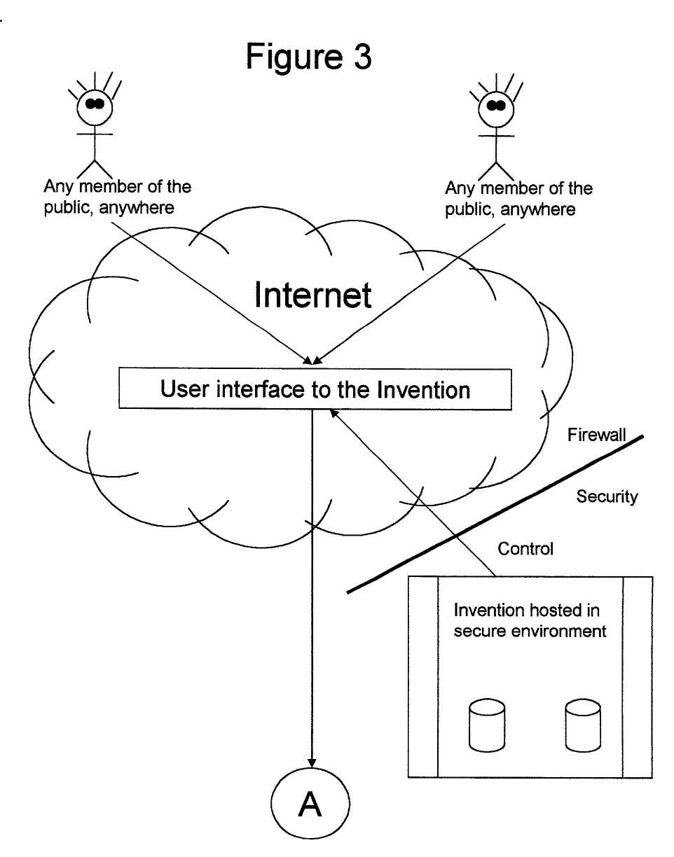

FIG. 4 illustrates three critical points: 1) the User has may elect to report an incident, that has happened to an organization (such as hacking or denial of service) or report a tip (such as the User believes that his/her relative is hacking into websites) or report an incident, that happened to him/her or to someone s/he knows (such as s/he received child pornography); 2) the system relies on personal information about the User in order to tailor the Wizard to provide the most intuitive process possible (the Wizard phrases questions differently based on the age of the User); and, 3) the User reporting the incident does not have to be the victim of the incident and when the User is not the victim, the system will prompt the User to enter personal information about the victim (such as name, age, home address, phone).

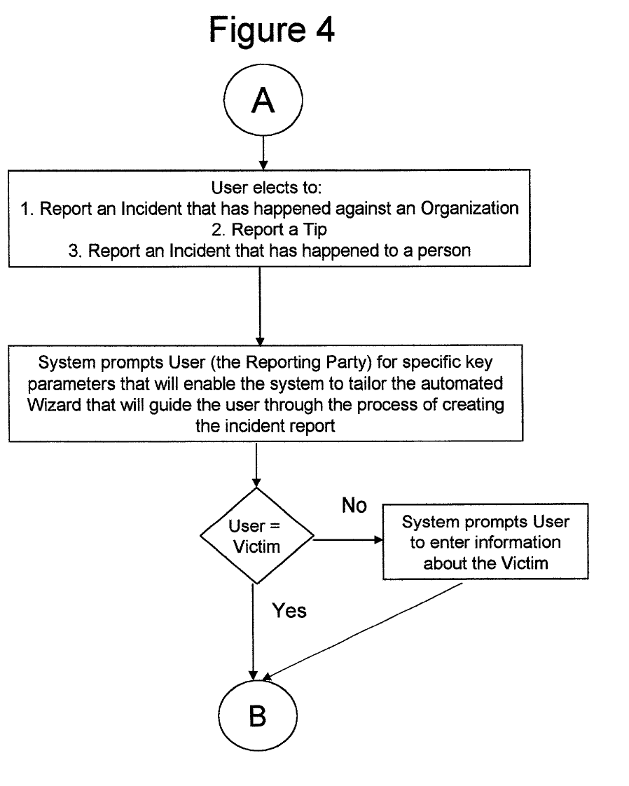

FIG. 5 depicts a highly simplified view of the process by which the system collects and stores personal information relevant to the person reporting the incident (such as name, home address, phone, contact preference).

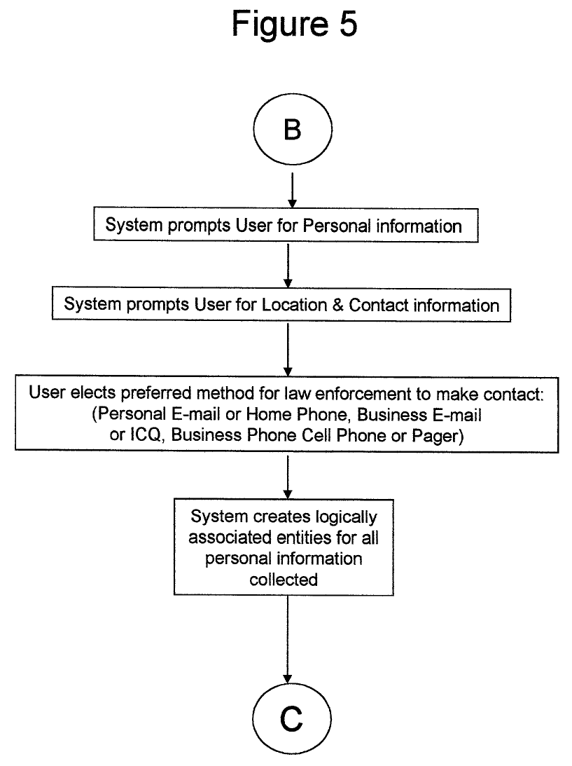

FIG. 6 depicts how this invention uses an intelligent Wizard to guide the User through the process of entering information specific to the incident and how the Wizard uses sets of questions and answers to define the processing logic. The Wizard presents a question and answer set to the User. The User selects the answer that best relates to his/her situation and the incident that s/he is reporting. The execution of the logic within this invention is based on the answer that the User selects. The Wizard presents an iterative set of questions and answers and will reiterate this process until the system can logically determine the nature of the incident (e.g. stalking, sexual solicitation, pornography) and can automatically select the type of incident that has occurred.

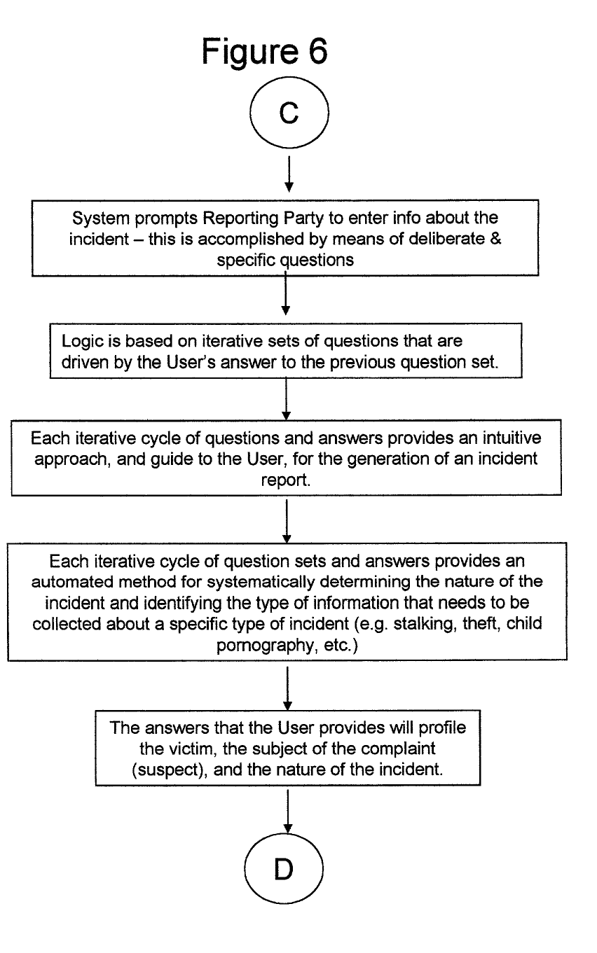

FIG. 7 provides another view of the logic described in FIG. 6.

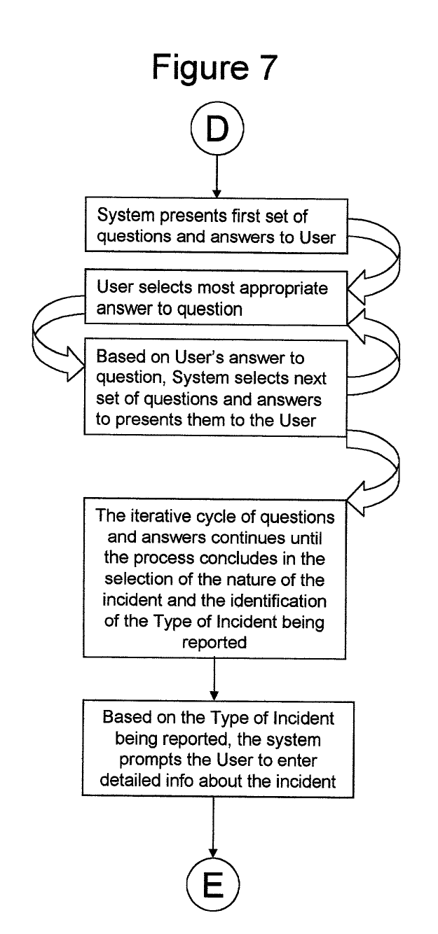

FIG. 8 depicts how the system creates logically associated components related to an incident and stores those components within a data repository.

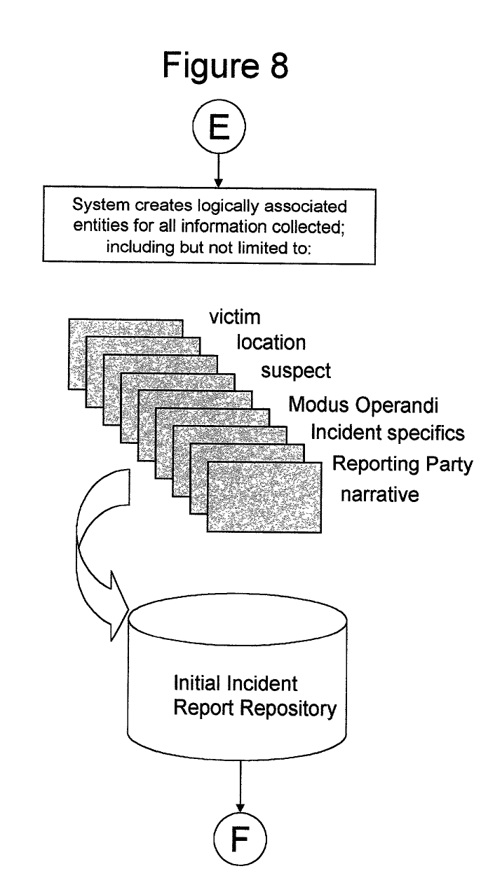

FIG. 9 demonstrates that when specific values within an incident report match pre-defined agency notification parameters, one or more law enforcement agencies or other authorized agencies, will automatically be notified that an incident has been created. The notification can be made via a multiplicity of methods (e.g. email, fax, API). Additionally, FIG. 9 demonstrates that the system provides the User with education points relevant to the type of incident reported.

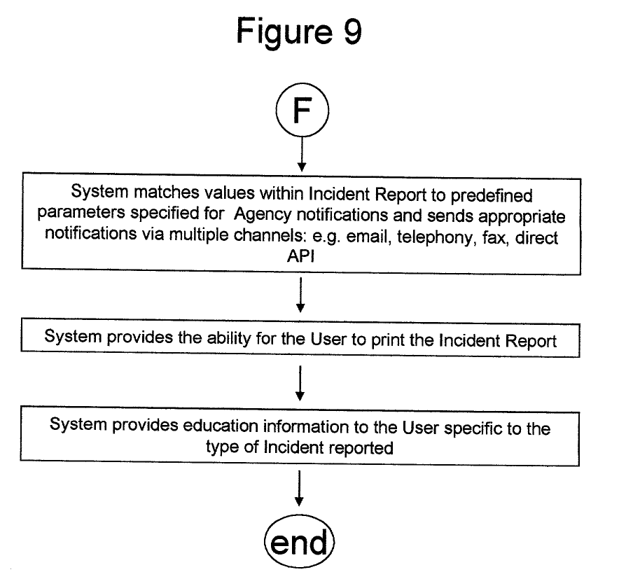

### DETAILED DESCRIPTION OF THE INVENTION

This invention will allow law enforcement agencies to make a profound paradigm shift in the method in which incident reports are collected. This invention provides the technology and methodology for the public-at-large to electronically initiate the report of an incident. This invention allows the public to electronically report an incident via the Internet, an intranet, or an extranet as opposed to reporting an incident via the telephone or by direct contact with a law enforcement officer. Additionally, this invention will provide law enforcement agencies with a collaborative, investigative tool via a comprehensive repository of data. This investigative repository provides unprecedented access to realtime, incident information by law enforcement agencies nationwide (potentially worldwide). This will be an especially powerful tool in the investigation of electronic (Internet-related) crimes.

The essence of this invention is that it will provide an innovative, electronic means for the public to contact law enforcement agencies concerning the report of any non life-threatening incident; including, potential Internet-related crimes. It provides an on-line reporting mechanism whereby kids, teens, and adults can report an incident to law enforcement: including, but not limited to computer intrusion crimes such as fraud, denial of service (hacking), pornography, sexual solicitation, stalking and harassment. The victim, or any person who is aware of an incident, will be able to initiate an incident report, after which the system will notify one or more law enforcement agencies of the report. After a citizen reports an incident, this invention will provide the ability for a law enforcement officer or agency designee with the ability to view—online—the incident report and with the ability to modify elements of the report during the investigation. This invention will also provide an investigative repository, a data warehouse, that contains any incident reported from any geographical location. This investigative repository will allow the matching of incidents across jurisdictions. Currently, most law enforcement applications and data repositories are “siloed,” meaning, they are solely contained within their agencies and the data within are unobtainable by law enforcement personnel from other agencies. Collaboration is key to relating incidents across jurisdictional boundaries and to solving crimes in this Internet-enabled environment. With the expansion of the Internet into millions of homes, one predator can now reach countless victims with ease, without regard to geographical boundaries, and all without ever leaving home. This invention is designed to provide law enforcement and justice agencies with an Internet-centric incident reporting tool to collect, store and access incident information that will aid in the apprehension and prosecution of persons who commit crimes; especially crimes committed in cyber space.

To best understand this invention a Glossary of Terms is provided. These terms will be used throughout the description of the invention.

Cyber Crime: Any incident that occurs over the Internet that violates any law.

Cyber Criminal: Any person that utilizes the Internet to commit a crime (such as hacking) or that utilizes the Internet to aid in the commission of a crime (such as to entice a child to meet and have sex).

Cyber Incident: Any event that occurs via the Internet, whether or not a law has been violated.

Cyber Report: An interchangeable term for the “Initial Incident Report” that is filled out online by the reporting party. See the description below for Incident Report.

Incident: Any event that is reported to law enforcement through this invention. An incident, in actuality, may or may not be criminal in nature. The law enforcement officer or agency designee that reviews the incident will make the determination as to whether a criminal act has occurred.

Incident Report: A cyber form provided through this invention that is used to collect information about an event that a reporting party believes should be investigated by law enforcement. Within this invention, two terms may be associated with an incident report: an Initial Incident Report and an Official Incident Report. An Initial Incident Report is the report that is completed by the reporting party. The information contained in this report has not been verified. An Official Incident Report is the report that is completed by a law enforcement officer or agency designee. The information contained in this report may be the result of the officer's follow-up conversation with the reporting party, and/or victim, and may contain additional information entered by the officer during the investigation of the incident.

Incident Report Components: An Incident Report is a logical, versus physical, association of all elements of an incident; including, but not limited to: Reporting Party information, Victim information, Suspect information, Location information, Vehicle information, Modus Operandi (MO) information, Cyber-crime descriptor information, and a Narrative about the incident. Common information about the Reporting Party, Victim, and Suspect may include such data items as name, date of birth, identification documentation (e.g. SSN, Driver's license). Suspect information may also contain descriptor data items such as hair color, height, tattoos, chat room name or email ID. Location information may include various addresses related to the reporting party, victim, and suspect as well as the location of the incident. Vehicle information may include Make, Model and color of any vehicle involved in the incident. Modus Operandi may include descriptors about how the suspect operates (via chat rooms, email, etc.). Cyber-crime descriptor information may include technical data items associated with the incident. The Narrative is a free-form section where the reporting party relays the details of the incident. Many of the components of the incident report will be unknown to the reporting party. All components of the incident report are subject to modification by the investigating officer; however, the integrity of the original data—as entered by the reporting party—will be protected. All modifications by law enforcement officer or agency designee will be stored in a modified version of the incident report.

Jurisdiction: A term used to describe the territorial range over which a law enforcement agency has authority or control.

Law Enforcement: A collective term for any police department, sheriff's department, federal policing agency, or judicial agency engaged in the fight against criminal activity.

Law Enforcement Officer: A collective term for any person, within any law enforcement or judicial agency, who has sworn peace officer powers. This person may be a reserve officer, a deputy sheriff, a police officer, a marshal, or any other law enforcement of judicial agent.

Law Enforcement Agency Designee: A collective term for any person, sworn or non-sworn, who has been granted authority by a Law Enforcement Agency to access an incident report.

Reporting Party: Any person who initiates an incident report. The reporting party does not have to be the victim, The reporting party may know of an incident that occurred against another person or organization and elects to file the report.

Suspect: A person who is reported as the aggressor in an incident. A suspect is not necessarily a criminal, given that an incident is not necessarily a criminal act.

Tip: A report filed by a person who either knows of a crime that has occurred or who suspects that someone they know is involved in criminal activity. This person may or may not know the details about the victim, or much about the crime, but has some information about the suspect and possibly about the incident (potential incident). Example: a fifteen year-old girl overhears a classmate bragging to his friends about hacking a dot.com's website. She could report this as a tip. It is important to note that a tip may be about any potential threat or event (e.g. potential terrorist activity, potential school shooting) or may be about an event that has already transpired.

Victim: The victim may either be a person who is the object of an incident or may be an organization that is the object of an incident (ex: denial of service attack is generally targeted against an organization/business).

At the very core of this invention is the Incident Report. It is a specific event—an incident—that triggers the need for a person to contact a law enforcement agency, and it is through the Incident Report that the details of the event are relayed to a law enforcement agency. Accordingly, it is from the Incident Report that data elements are extracted and stored in an investigative repository for collaborative and investigative activities among law enforcement agencies.

This invention utilizes an online wizard (referred to as the Reporting Wizard) to guide the reporting party through the process of completing the Incident Report. The goal of this wizard is to ensure that this process is as intuitive and as simple as possible. It is critical that children, the elderly, any one be able to complete the process. Because of the simplicity of use designed into this invention, a person reporting an incident will not even have to be cognizant of the full concept of an Incident Report and its components. The reporting party will be guided through the process by a series of questions and at the conclusion of the process the logical components of the Incident Report will have been automatically captured and stored in the repository.

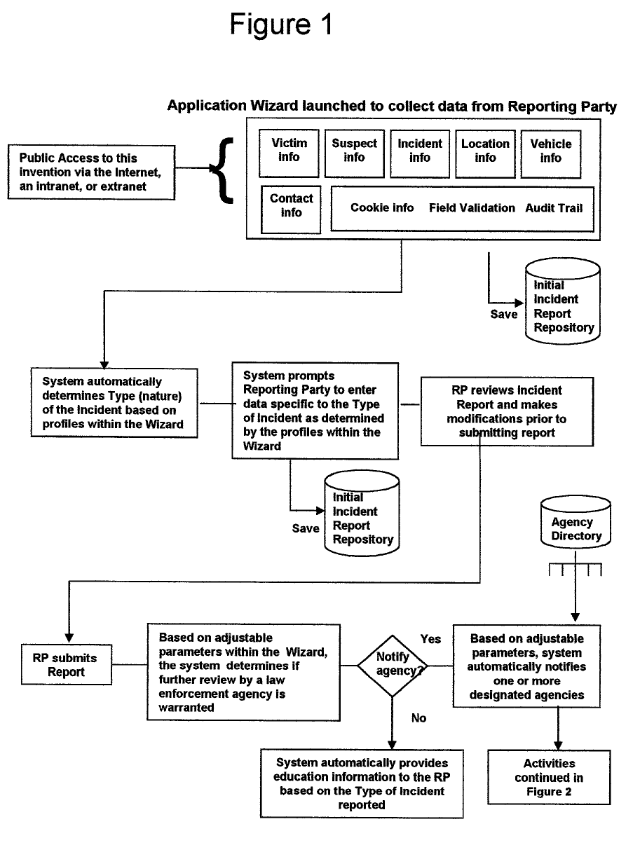

The following paragraphs describe this invention from the perspective of the Reporting Party; specifically, how the Reporting Party interacts with the Public-initiated incident reporting process and methods. FIG. 1 depicts the high-level process of how the Reporting Party engages the Reporting Wizard (a central concept within this invention), how the Reporting Party enters the relevant incident report data, and when the system notifies law enforcement of the Public-initiated Incident Report.

When an event occurs, that a person believes should be reported to law enforcement, that person (referred to as the reporting party) will access this invention by clicking on an icon on his/her desktop or by accessing a website (via the Internet, an intranet, or an extranet) that launches the reporting wizard defined by this invention.

When a person initiates the reporting wizard, defined by this invention, a link will be established between the remote user and the process defined within this invention.

The Reporting Wizard will guide the reporting party through the process of completing an Incident Report. An initial step in the process is to collect personal information about the reporting party. This information includes, but is not limited to: name (Prefix, Last, First, Middle, suffix), home address, work address, phone numbers (home, work, cell), date of birth, age, social security number, drivers license number, email ID, parents' names (if a minor), reporting party's relationship to the incident (victim or witness), best way for an officer to contact the reporting party (email, phone). Note: collecting both date of birth and age is not redundant. It is often critical to know the age of the person at the time of the incident and it would be a burden on the application if it had to contain a coded routine to compute “age at time of incident” every time the report or the data is accessed.

During this process, the reporting party will indicate if s/he is the victim in this incident or is a witness to the incident. When the reporting party is the witness, not the victim, the Reporting Wizard will prompt the reporting party for information about the victim; including, but not limited to: name (prefix, Last, First, Middle, suffix), home address, work address, phone numbers (home, work, cell), date of birth, age, race, email ID, parents' names (if a minor), relationship to incident (victim). When the reporting party is the victim, the Reporting Wizard will prompt the reporting party for information about witnesses to the incident; including, but not limited to: name (prefix, Last, First, Middle, suffix), home address, work address, phone numbers (home, work, cell), date of birth, age, race, email ID, parents' names (if a minor), relationship to incident (victim). There can be multiple witnesses or no witnesses. Additionally, when the incident is a “tip,” the reporting party may not even have details about the victim. As in the earlier example where a fifteen year-old girl overhears a classmate bragging to his friends about hacking a dot.com's website, she can file an incident report as a tip and not know which dot.com (business) was the victim.

It is important to note that an organization (a business) can be the victim. A case in point would be a denial of service crime in which the victim is an organization, not an individual. When the victim is an organization, the following information will be collected; including, but not limited to: organization name, address (physical location), mailing address, relationship to incident (victim). In this case, the reporting party will be recognized as the contact for the organization.

After the information has been collected about the reporting party, the victim, and any witnesses, the Reporting Wizard will prompt the reporting party for information relevant to the incident itself. This information includes, but is not limited to: date of incident, time of incident, day of week, physical location, and the date the incident report is created (current system date).

For al reports of incidents, whether the victim is an individual or an organization, and whether the incident is Internet related or not, the reporting party will be guided through the process by a series of questions posed in different ways to determine the type of incident that occurred. It is important that persons of all ages and mental capacity be able to complete this process. Based on the answers provided by the reporting party, the Reporting Wizard will prompt the reporting party to enter specific information that has a direct correlation to the system-posed questions and the reporting party's answers. The ability for the system to profile an incident is a unique and extremely complex component of this invention.

After the reporting party has been guided through the iterative question and answer activity described above, s/he will be prompted to provide a narrative of the incident. This is a free form, essay format. Once the narrative is completed, the Reporting Wizard will prompt the reporting party to provide any information that is known about the suspect(s). This information may include, but is not limited to: name (Last, First, Middle, suffix), home address, work address, phone numbers (home, work, cell), date of birth, age (or age range), race, parents' names (if a minor), relationship to incident (suspect), relationship to victim (stranger, friend, relative), height, weight, build (slim, heavy, tall, short) tattoos, scars, facial hair (moustache), hair (color, length, style), eye color, other distinctive characteristics, email ID, chat room name, and other data.

After the reporting party completes the description of the suspect, the Reporting Wizard will ask the reporting party if s/he has any knowledge of the suspect's vehicle. When the reporting party has knowledge of the suspect's vehicle, the Reporting Wizard will collect the known information; including, but is not limited to: make, model, series, color (top, bottom), number of doors, license plate number, and license plate state.

At this point the reporting party has provided all of the known details of the incident. The system will now automatically capture data pertinent to the filing of the Incident Report; such as a system date and time stamp at the moment that the incident report is submitted. Other details, and audit information, will be automatically captured and saved with the incident report.

The following paragraphs describe this invention from the perspective of the computerized system; specifically, how the system performs during the Public-initiated incident reporting process.

At the moment that an incident report is submitted, the system will automatically notify one or more law enforcement agencies (or other specialized agencies, such as the Center for Missing and Exploited Children) that an incident report has been submitted. The mechanics of this notification are based on variable parameters within the system. These parameters may include, but are not limited to: geographical location of the incident, whether the incident involves the exploitation of children, whether the incident is classified as a tip.

Throughout the process or creating the incident report, the system has periodically populated the Investigative Repository with real-time data relevant to the incident. The data within the repository is available, through the use of analytical technologies, for investigative and analytic processes that are invaluable to the association of perpetrators to multiple incidents and to the apprehension and prosecution of those perpetrators.

Another significant aspect of this system is the Application Program Interface (API); that will be provided for law enforcement agencies that want to extract incident data from the repository to be populated/integrated with their local Records Management Systems or incident reporting systems. This invention is a complimentary, front-end component to existing Records Management Systems and legacy incident reporting systems.

Validation. Virtually every field that is entered in the incident report will be validated. The system will provide multiple validation options and techniques; including, but not limited to: lookup tables, lists, and field format maps.

Audit. A complete audit history will be maintained of all activity within this invention. From the time that the reporting party overtly accepts that his/her personal information will be captured, the system will log all activity within this system. An audit history will be maintained on every action committed by the reporting party as well as every action executed by a law enforcement agency designee.

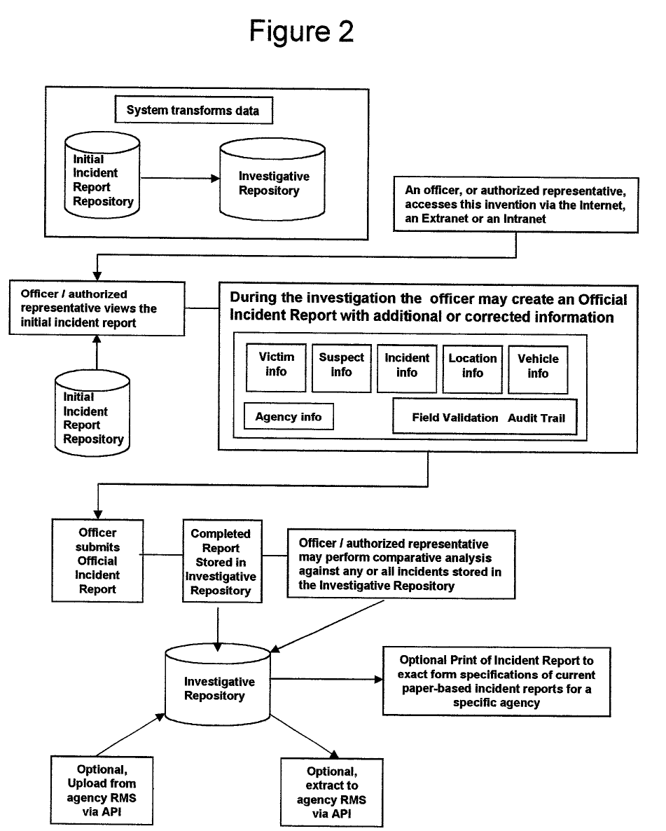

After an incident report has been initiated, the system will provide law enforcement officers or agency designees with access to the data contained within the incident report. The following paragraphs describe this invention from the perspective of Law Enforcement; specifically how a law enforcement officer or agency designee interacts with the Public-initiated incident reporting process. FIG. 2 depicts the high-level process of how a law enforcement officer engages this invention to review, investigate and modify a Public-initiated Incident Report. It also depicts the ability of the system to share data, through API's with local law enforcement agency legacy systems.

Historically, an incident report has been initiated by, and completed by, a law enforcement officer, not the public-at-large. With the advent of the Internet and web technologies, it is now possible for the incident report to be initiated by the Public. However, there is certain information on the report that the Public would not be in a position to complete, one example is: ascribing a Penal Code Section and Penal Code description to the incident. Thus, this invention recognizes the distinction between data elements and protects or enables field entry accordingly.

This invention will have a secured area that only authenticated law enforcement officers and agency designees can access. The system will provide the law enforcement officer or agency designee with access to each logical component of the incident report. The system will also allow the law enforcement officer or agency designee to modify additional elements of the incident report; including, but are not limited to: case number (if a case is opened), case status, Penal Code Section, Penal Code description, whether an interpreter was needed when talking with a victim or witness, related incidents, evidence collected, and crime type.

In conclusion, this invention is a computerized system (constructed with state-of-the-art web technologies and database management systems) that leverages the public accessibility afforded by the Internet to provide a computerized mechanism by which members of the public-at-large can self-initiate the reporting of an incident to one or more law enforcement agencies via the Internet, an intranet, or an extranet. This invention captures data pertinent to the incident via an application wizard that guides the reporting party through the incident reporting process. And, during this process, profiles the incident based on logically associated sets of questions and answers. At the conclusion of the incident reporting processes, this invention automatically notifies one or more law enforcement agencies of the creation of the report and makes the incident report data available to law enforcement for investigative purposes. After the inception of the publicinitiated incident report, an authorized representative of a law enforcement agency will be provided access, by this system, to the elements within the incident report against which the authorized representative may take appropriate action. Appropriate action may include, but is not limited to: the review and investigation of the incident report, the creation of an agency-specific incident report, the automated export of elements within the incident report to the agency's local records management system or incident reporting database/system, or the determination that no further action is necessary. This system provides an unprecedented investigative data repository containing logically related data elements collected from incidents spanning jurisdictional boundaries and without geographical limitation; and, as such, this invention facilitates communication and collaboration among law enforcement agencies by creating an innovative method for the collection of publicinitiated incident information and an invaluable and powerful investigative tool.

What we claim is:

1. This is a computerized system constructed with state-of-the-art web technologies and database management systems that leverages the public accessibility afforded by the Internet to provide a computerized mechanism by which members of the public-at-large can self-initiate the reporting of an incident (an event—criminal or non-criminal) to one or more law enforcement agencies via the Internet, an Intranet, or an Extranet, whereby the system captures data pertinent to the incident in the form of a logical association of all elements of the incident (including, but not limited to: victim, witness, reporting party, location, incident type, narrative, modus operandi, incident details, and suspect information) and makes said data available to law enforcement following the automatic notification of one or more law enforcement agencies of the initiation of an incident report; and, provides the ability for one or more law enforcement agencies to access said data across multiple incident reports for collaborative and investigative purposes.

2. A computerized system as defined in claim 1 wherein any person, i.e. any member of the public-at-large, not necessitated as being a member of a law enforcement agency, can access the system via the Internet, an intranet, or an extranet connection and thus execute the methods of this invention to self-initiate the creation of an Incident Report comprised of logical data components that when associated as a whole reflect the circumstances of an event (either criminal or non-criminal in nature) witnessed by, experienced by, or in some means known to the person reporting the incident.

3. The methods of this invention from claim 2—by means of an application wizard—facilitate, prompt, guide, lead, a person through the process of creating the logical data components that expressly define the characteristics of an incident (an event); including methods for:
eliciting data/information pertaining to the person reporting the incident;
eliciting data/information pertaining to the victim of the incident;
eliciting data/information pertaining to the person suspected of causing the incident;
eliciting data/information pertinent to the incident itself (e.g. date, time);
eliciting data/information pertinent to a specific type of incident (e.g. fraud, pornography, theft, sexual solicitation);
eliciting data/information pertinent to location (e.g. the location where the incident occurred, the home address of the victim);
eliciting data/information that describe or identify any/all persons involved in the incident (e.g. physical descriptors such as height, weight and identifiers such as email name or social security number);
eliciting data/information pertinent to the modus operandi employed during the incident (e.g., subject pretended to be a child); and,
eliciting a freeform narrative describing the incident.

4. Automatic notification as proffered in claim 1 provides the unprecedented ability of a computerized system to automatically notify one or more law enforcement agencies, or other associated agencies, of the submission of an incident report when characteristics of the incident match pre-defined, adjustable parameters; including, but not limited to: location of the incident, location of the victim, type of incident, estimated dollar loss.

5. Automatic notification as defined in claim 4 may include notification of one or more agencies via one or more methods of communication: messaging between computer systems, integration and data transfer between computer systems, electronic mail, fax, telephony, and/or personal contact by monitoring agency personnel.

6. Access to data, by law enforcement or other designated agencies, as defined in claim 1 is distinguishable as either: access to data relevant to a single incident report against which an agency may elect to take action, or, as access to data contained in multiple incident reports against which an agency may compile statistics, identify trends, search for relationships and global patterns, correlate commonalities, and utilize for collaborative and investigative purposes.

7. The method of claim 6 whereby an agency accesses data relevant to a single incident report provides the ability to view, modify, and/or export all logically associated components of the designated incident report.

8. The method of claim 6 whereby an agency accesses data contained in multiple incident reports provides global access to any or all incident report data contained in the data repository and provides the ability to invoke decision support system (DSS), data mining, search engine, and reporting tools against any or all incident report data contained in said data repository.

9. The method of global access as defined in claim 8 may be limited by the invocation of one or more optional parameters used to define the domain of the data; including, but not limited to: domain limiting parameters such as geographical location of incidents and agency notification qualifiers associated with incidents.

10. The method of global access as defined in claim 8 may remain unlimited and thus the domain of the data will be unrestricted and not bound by agency qualifiers or geographical boundaries providing an unprecedented method for interagency collaboration within the global domain of the repository.

11. The application wizard of claim 3 is a deliberate presentation of questions, answers, and statements that when presented to the person reporting the incident and said person selects a specific statement from the set of statements presented or selects a specific answer to a specific question will cause the system to execute specific application logic that facilitates, prompts, guides, leads, the person through the process of creating the incident report relevant to the type of incident (e.g. pornography, stalking) being reported.

12. The method of claim 11, the application wizard, provides an imbedded intelligence that programmatically derives the type of incident being reported and directs the system to execute application logic directly related to each specific type of incident, thus, creating a process that is intuitive and focused in its collection of relevant data.
